(19) United States
(12) Patent Application Publication
(10) Pub. No.: US 2011/0265528 A1
(43) Pub. Date: Nov. 3, 2011

(54) MECHANICALLY OPERATED ELECTRIC LOCK

(76) Inventor: Simo Saari, Espoo (FI)

(21) Appl. No.: 13/143,240

(22) PCT Filed: Dec. 29, 2009
(86) PCT No.: PCT/FI0209/051045

§ 371 Date: Jul. 5, 2011

(30) Foreign Application Priority Data
Jan. 5, 2009 (FI) 20095004

(51) Int. Cl. E05B 47/00; E05B 65/00

(52) U.S. Cl. 70/91

(57) ABSTRACT

A mechanically operated lock which can operated by electrical control. The lock comprises a door handle rotatable door handle spindle (1) and a turn-knob or door handle rotatable turn spindle (2). The lock comprises a housing mountable or a door inner surface, into which said spindles (1, 2) extend. A mechanism (40) interconnects the spindles (1, 2) and is capable of engaging, by way of an electric control (5, 6, 7), the spindles (1, 2) with each other for a relative mechanical drive link, such that a rotation of the door handle spindle (1) translates into a rotational motion of the turn spindle (2) as well. The drive link (40) is adapted to decouple either automatically after a delay time or as the lock is opened by pressing the door handle. A piezoelectric actuator (20, 22, 23, 25, 26, 27), in a mode activated by an electrical control (5, 24), is adapted to immovably lock a bolt or plunger (27) which, in its immovably locked condition, couples said drive link as the door handle spindle (1) is rotated. Without the electrical control of the piezoelectric actuator, the bolt or plunger (27) is adapted, by yielding to the weak returning force of a spring (23), to disable or not to activate a coupling of the drive link as the door handle spindle (1) is rotated.

The invention relates to a mechanically operated electric lock which can be opened by electrical control, the lock comprising a doorhandle spindle, rotatable by a doorhandle, and a turn spindle, rotatable by a turn-knob or doorhandle, as well as a mechanism interconnecting the spindles and being capable of engaging, by way of an electric control, the spindles with each other for a relative mechanical drive link, such that a rotation of the doorhandle spindle translates into a rotational motion of the turn spindle as well, and that said drive link is adapted to decouple either automatically after a delay time or as the lock is opened by pressing or turning the doorhandle.

One problem relevant to home care of the elderly involves the distribution and management of a sufficiently large number of keys. When dealing with electrically controlled locks, this problem has been overcome by recent systems, enabling the opening of locks with a mobile communicator which transmits to a server of the control center a request to open a specific door and, after checking the user record for the rights of a requesting party, the server supplies the mobile communicator with necessary data to open the requested door. However, such a system cannot be used in connection with exclusively key-operated locks.

A lock of the above mentioned type is known from the Patent publication SE 529017 C2. This prior known electric lock includes solenoid-operated levers capable of setting the lock in an opening position as the solenoid receives a current. The solenoid's power consumption is of such a magnitude that the excessively frequent need of replacing the batteries makes this accessory impractical. Also, the complicated lever system and the need to use two solenoids make the accessory expensive. A mains-current operated version of the lock is not practical in terms of installation engineering and for many other reasons. However, there would also be a demand for a type of electric locks with a consumption of power low enough for sustaining the same in a battery-operated version for several years without a battery replacement. In order to achieve this objective, the unlocking must not be based on a solenoid-operated active application of force. An insight in the invention is that, as the opening function is based on using a piezoelectric or corresponding low energy actuator for disabling a movement of the bolt or plunger, the energy consumption is extremely slight.

An object of the invention is to provide a battery-operated lock accessory, by means of which a mechanically operated lock is convertible readily and at low cost to an electrically operated lock which has an extremely slight consumption of energy.

This object is achieved by the invention on the basis of the characterizing features presented in claim 1. Preferred embodiments of the invention are presented in the dependent claims.

Two exemplary embodiments of the invention will now be described more closely with reference to the accompanying drawings, in which

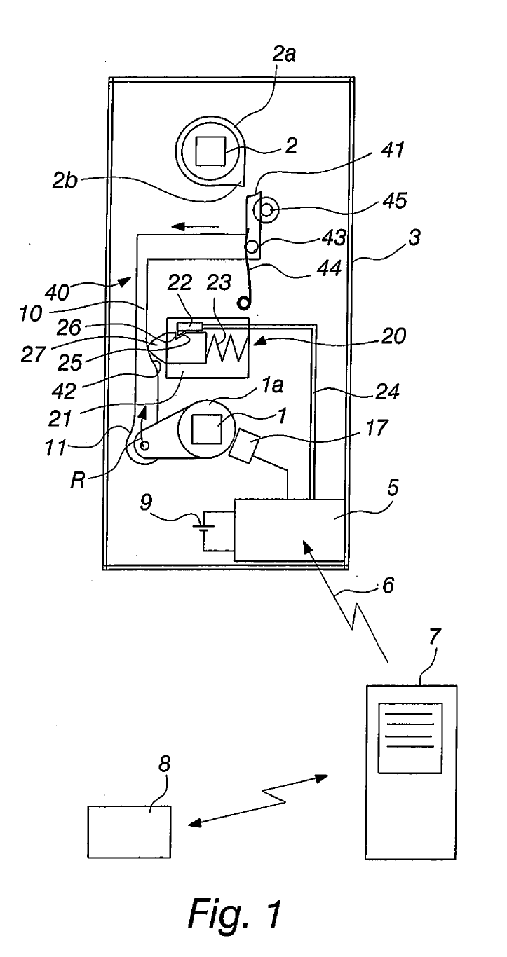

FIG. 1 shows a lock accessory of the invention in an opened condition, as well as schematically a mobile communicator 7 used for controlling the accessory, and a server 8 used for maintaining therein a centralized record of access rights. The lock frame and mechanism may be of any design of a key-operated lock (not shown),

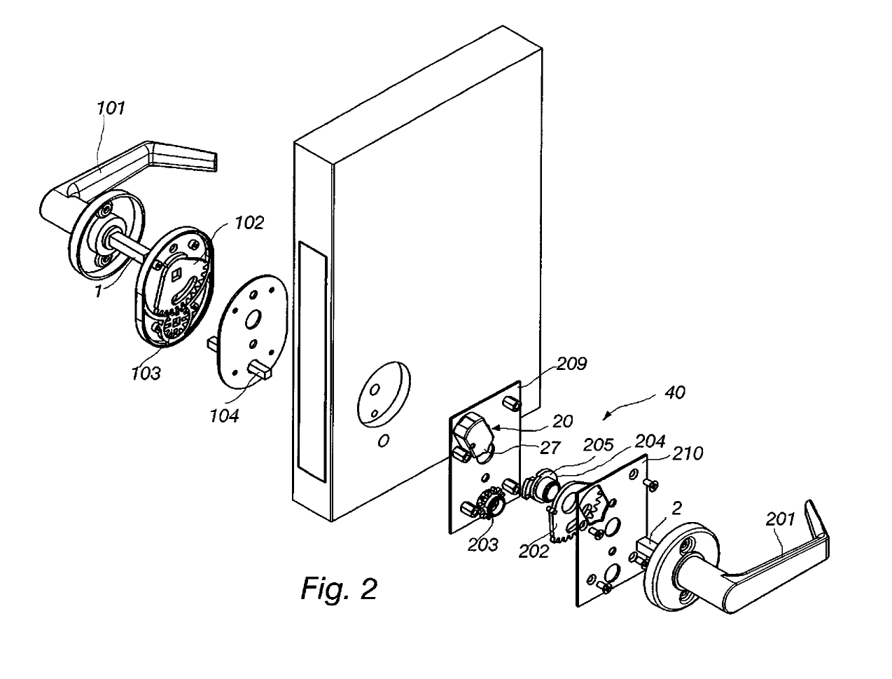

FIG. 2 shows another embodiment of the invention in an axonometric exploded view, and

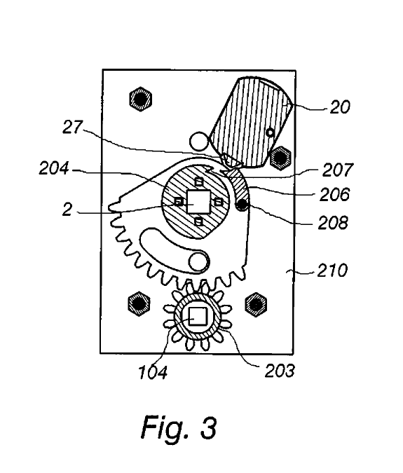

FIG. 3 shows an assembled detail of FIG. 2 inside the door.

The embodiment of FIG. 1 is described first. The lock, in which the invention is applied, includes a doorhandle (not shown) rotatable doorhandle spindle 1 and a turn-knob or doorhandle (not shown) rotatable turn spindle 2. The doorhandle or the turn knob relevant to spindle 2 is located inside the door, and the doorhandle spindle 1 is associated or can be fitted with a doorhandle external of the door. With the lock in a dead-bolted position, the doorhandle and the doorhandle spindle 1 associated therewith perform a dead travel as the doorhandle is pressed, i.e. the door does not open. In an accessory of the invention, this dead travel can be transmitted by means of an electrically on- and off-controlled mechanism to the turn spindle 2, whereby even a dead-bolted lock can be switched to an electrically opening mode by pressing a doorhandle external of the door.

The invention can be implemented as an accessory of a key operated lock. The accessory includes a housing 3 mountable on a door surface inside the door, into which the spindles 1 and 2 extend. The housing 3 contains sleeves 1a, 2a fitted around and rotating with the spindles 1, 2, as well as a mechanism 40 interconnecting the sleeves and being capable of engaging, by way of an electric control, the sleeves with each other for a relative mechanical drive link. When the mechanical drive is coupled, a rotation of the doorhandle spindle 1 translates into a rotational motion of the turn spindle 2 as well. This drive link is adapted to decouple either automatically after a delay time or as the lock is opened in response to pressing the doorhandle, as will be described hereinafter.

The mechanical drive link 40 is established by a lever 10, whose first end 11 is bearing-mounted to the end of an eccentric cam protruding from the doorhandle sleeve 1a, i.e. at a distance from the axis of rotation of the doorhandle sleeve 1a. A second end of the lever 10 is designed as an L-shaped angle bar. The lever 10 has its second end provided with a profile 41 which provides an engagement lip, whereby an engagement profile 2b of the matching shape is provided on the periphery of the sleeve 2a of the turn spindle 2 The housing 3 is provided with a spring 44, biasing the lever 10 to the right in FIG. 2 against a limiter 45. With the lever 10 in this position, the mechanical drive link is in a decoupled condition, whereby the lock does not open by rotating the doorhandle spindle 1.

To the engagement with the lever 10 is brought a bolt or plunger 27, which is biased with a weak force, e.g. by a spring element 23, against the lever 10 in a direction transverse to the longitudinal direction of the lever 10. The bolt or plunger 27 is provided preferably in a separate body member 21, which is also adapted to house the spring 23 and a piezoelectric element 22. Upon receiving an electric control current, the piezoelectric element 22 or corresponding low energy element has a function of disabling a movement of the bolt or plunger 27. When disconnected from the electric control, the bolt or plunger 27 travels to the right in FIG. 1, being carried by a guide surface 42 formed on the lever 10 as the lever 10 moves upward with the spring 44 pressing the lever 10 against the limiter 45. Thus, the spring 44 has a force which exceeds that of the spring 23. Hence, the lever 10 remains substantially stationary in lateral direction, although, upon rotation of the spindle 1 (an arrow R), the lever 10 moves upwards. Thereby, the profiled second end 41 of the lever travels also upward past the above-mentioned profile 2b.

The bolt or plunger 27 can be locked for opening the door by means of the piezoelectric element 22. In this case, the piezoelectric element 22 has its stopper means, e.g. a small bar 25, inserted in a coincident detent 26 present in the bolt or plunger 27. Upon rotating the spindle 1, as indicated by the arrow R, the lever 10 moves upwards. At the same time, the lever 10 shifts or turns to the left as the guide surface 42 glides against the immovably locked bolt or plunger 27. In response to this, the lever 10 has its second end 41 moving to an engagement with the profile 2b. As the lever continues its upward travel, the spindle 2 rotates as well, thus opening the lock.

The pushing end 41 of the lever 10 and the profile 2b are designed in view of remaining in engagement throughout a necessary rotational motion, which is typically within the range of 25° to 35°. The end 41 and the profile 2b can be given a multitude of optional shapes.

The components 21-27 jointly make up a piezoelectric actuator 20, which is installable as a single unit in the housing 3. The electric control from a control unit 5 to the actuator 20 is transmitted by way of a cable 24. The bolt or plunger 27 can be locked to be immobile by means of low energy actuators other than the piezoelectric actuator. In practice, the locked bolt or plunger 27 is not completely immobile, but a very small limited movement is allowed and may be desirable in terms of functioning of the actuator 20.

The return spring 44 resets the lever 10 to the position, in which the pushing end 41 does not reach the point of contact with the engagement profile 2b, even if the doorhandle sleeve 1a were rotated. The piezoelectric actuator 20 has a working time which enables the lock to be opened with a doorhandle for just a specific time span, which has been set in the electric control unit 5. This control unit receives its operating power from a battery 9 and operates only when a server 8 of the service provider has given access right data to an individualized mobile communicator 7, which may carry a list of addresses for doors whose opening authorization can be requested therefrom.

The electric control unit 5 for the accessory or the mobile communicator 7 controlling the same can be adapted to emit an audio signal as soon as the electric control has coupled the drive link 40 between the sleeves 1a, 2a. As a result, the user knows that the lock is openable by applying a press on a doorhandle associated with the doorhandle spindle 1.

The accessory may also include a micro switch 17, which switches the accessory's electric control unit 5 to a standby mode in response to a rotational motion of the doorhandle spindle 1. This arrangement saves the battery 9 considerably, because the battery can thereby be in a totally power non-consuming state except when opening of the lock is desired. In this case, the first necessary step is to apply an activating press on the doorhandle and only then to transmit a control message from the mobile communicator 7 to the control unit 5. This communication may function over a bluetooth link or any other short range communication link.

Hence, the accessory of the invention is mounted inside a door, while a doorhandle relevant to the doorhandle spindle 1 is located outside the door (and usually also inside the door). Thus, in a dead-bolted position of the lock, the doorhandle and the doorhandle spindle 1 perform a dead travel unless the accessory's mechanical drive link 40 has been coupled by means of the electric control 5, 6, 7, 20.

In the embodiment of FIGS. 2 and 3 there is a doorhandle 101 outside a door and a doorhandle 201 inside the door. The doorhandle 101 is provided with a doorhandle spindle 1 and the doorhandle 201 is provided with a turn spindle 2.

The mechanism interconnecting the spindles 1 and 2 is as follows. A sector shaped gear 102 engages sprockets of a gear 103 which is at the end of an opening spindle 104. The opening spindle 104 extends through the door and is provided at its other end inside the door with another sprocket 203 which engages sprockets of another sector shaped gear 202. Gear 202 is rotatably mounted around the sleeve 204 such that the gear 202 and the sleeve 204 can rotate separately. The sleeve 204 is fitted around and rotates with the turn spindle 2. The sleeve 204 has an engagement profile 205 having a notch 207 which is shaped for co-operation with a claw at the end of lever 206 having its swivel axis 208 fixed on the gear 202. Lever 206 is biased by a spring (not shown) to swivel a limited distance outwards from engagement profile 205 such that the claw of lever 206 can pass the notch 207. Biasing force of lever 206 exceeds the force required to retract the plunger 27 of the actuator 20 when gear 202 rotates and the bevelled end of lever 206 pushes against the wedge shaped end surface of the plunger 27. Because the plunger 27 retracts, the doorhandle 101 makes an idle movement without opening the lock.

When the plunger 27 is locked immovable or allowed to move inwards only a very short distance, rotation of gear 202 urges the lever 206 against its biasing force towards the engagement profile 205, whereby the claw of lever 206 engages the notch 207 and further rotation of gear 202 turns the turn spindle 2, thereby opening the lock. Hence, the lock can be opened by turning the doorhandle 101 when the plunger 27 is locked by electrical control as explained previously. The locking of plunger 27 needs extremely minor amount of energy, and the lock is opened by hand force.

In this embodiment, the mechanism 40 interconnecting the spindles 1 and 2 is devided on both sides of the door, but the sensitive part of the mechanism 40, enabling opening of the lock is inside the door, between the casing plates 209 and 210, which makes the lock burglar-proof.

The accessory of the invention converts an ordinary Abloy lock or any other mechanically controlled lock into an electrically controlled lock. It is economical and quick to install and can be removed without leaving marks on the door.

The invention is not limited to the foregoing exemplary embodiments, but a skilled artisan will be able to implement the mechanical drive link 40 between the spindles 1 and 2 in a multitude of different ways by using various combinations of levers and/or pinions or gears. Essential in the invention is that locking the plunger 27 by electrical control enables opening the lock by hand force applied on the handle outside the door.

1. A mechanically operated electric lock which can be operated by electrical control, the lock comprising a doorhandle spindle (1), rotatable by a doorhandle, and a turn spindle (2), rotatable by a turn-knob or doorhandle, as well as a drive link mechanism (40) interconnecting the spindles (1, 2) and being capable of engaging, by way of an electric control (5, 6, 7), the spindles (1, 2) with each other for a relative force transmission by using the drive link mechanism (40), such that a rotation of the doorhandle spindle (1) 10 translates into a rotational motion of the turn spindle (2) as well, the drive link mechanism (40) being adapted to decouple either automatically after a delay time or as the lock is opened by pressing or turning the doorhandle, characterized in that a piezoelectric or corresponding low energy actuator (20, 22, 23, 25, 26, 27), in a mode activated by an electrical control (5, 24), is adapted to immovably lock a bolt or plunger (27) which, in its immovably locked condition, enables or activates said drive link mechanism (40) to become coupled in response to rotation of the doorhandle spindle (1) by hand force, thereby enabling opening of the lock by continued rotation of the doorhandle spindle, and that, without the electrical control of the piezoelectric or corresponding low energy actuator, said bolt or plunger (27) is adapted, by yielding to the weak returning force of a spring (23) or some other force device, to disable or not to activate the coupling of the drive link mechanism (40) as the doorhandle spindle (1) is rotated.

2. A lock according to claim 1, characterized in that an exclusively keyoperated lock is converted to an electrically operated lock by means of an accessory, comprising a housing mountable on a door inner surface, the doorhandle spindle (1) or an opening spindle (104) rotated by the doorhandle spindle (1) and the turn spindle (2) extending into the housing, the housing containing the drive link mechanism (40) and the low energy actuator (20, 22, 23, 25, 26, 27).

3. A lock according to claim 1, characterized in that a doorhandle sleeve (1a) is fitted around and is rotating with the doorhandle spindle (1), a sleeve (2a) of the turn spindle (2) is fitted around and is rotating with the turn spindle (2), and that the drive link mechanism (40) of the spindles (1, 2) is provided by means of a lever (10), having its first end (11) bearing-mounted to the doorhandle sleeve (1a) at a distance from the doorhandle sleeve's (1a) rotational axis, and its second end is designed as an engagement lip (41), whereby an engagement profile (2b) of the matching shape is designed on the periphery of the sleeve (2a) of the turn spindle (2), and that the low energy actuator (20, 22, 23, 25, 26, 27) is adapted, under the guidance of its locked bolt or plunger (27), to pivot the movable lever (10) to an engagement position in which the engagement lip (41) takes hold of said engagement profile (2b) as the doorhandle sleeve (1a) is rotated, and that a return spring (44) is adapted to reset the returning lever (10) to a position in which the engagement lip (41) does not reach the point of contact with the engagement profile (2b), even if the doorhandle sleeve (1a) were rotated.

4. A lock according to claim 3, characterized in that the lever (10) is formed with a guide surface (42), whereby said bolt or plunger (27), being guided thereby, travels back and forth against the force of a spring (23) in response to a reciprocating rotational motion of the doorhandle spindle (1) as the low energy actuator is in disengagement from the electric control as the low energy actuator is in disengagement from the electric control.

5. A lock according to claim 1, characterized in that the interconnecting mechanism (40) includes an opening spindle (104) extending through the door and having gears (103, 203) at its opposite ends.

6. A lock according to claim 5, characterized in that the gear (203) at the end of the opening spindle (104) inside the door has its sprockets in engagement with sprockets of a gear (202) which rotates the turn spindle (2) whenever the actuator (20) is electrically controlled to lock the plunger (27) immobile or substantially immobile allowing only a small limited movement.

7. A lock according to claim 6, characterized in that the turn spindle (2) rotating gear (202) is rotatably mounted around a sleeve (204) which is fitted around and rotates with the turn spindle (2), the sleeve (204) having an engagement profile (205) with a notch (207) which is shaped for cooperation with a claw at the end of a lever (206) which has its swivel axis (208) fixed on the turn spindle rotating gear (202).

8. A lock according to claim 7, characterized in that the lever (206) is biased by a spring to swivel outwards a limited distance from the engagement profile (205) such that the claw of lever (206) can pass the notch (207) unless the plunger (27) is locked to urge the lever (206) towards the engagement profile (205) as the turn spindle rotating gear (202) is rotated.

9. A lock according to claim 1, characterized in that the lock includes an electric control unit (5) and a micro switch (17), which switches the lock's electric control unit (5) to a standby mode in response to a rotational motion of the doorhandle spindle (1).

10. A lock according to claim 1, characterized in that the electric control unit (5) of the lock, or a mobile communicator (7) controlling the same, is adapted to emit an audio signal as soon as the coupling readiness of the drive link mechanism (40) between the spindles (1, 2) has been enabled or activated by the electric control.

11. A lock according to claim 1, characterized in that the doorhandle associated with the doorhandle spindle (1) is present outside the door, whereby, in a dead-bolted position of the lock, the doorhandle and the doorhandle spindle (1) perform a dead travel upon pressing the doorhandle unless the coupling readiness of the drive link mechanism (40) has been enabled or activated by means of the electric control (5, 6, 7).
